(19) United States
(12) Patent Application Publication
(10) Pub. No.: US 2021/0026167 A1
(43) Pub. Date: Jan. 28, 2021

(54) OPTICAL MODULATOR

(71) Applicant: SUMITOMO OSAKA CEMENT CO., LTD., Tokyo (JP)

(72) Inventors: Yuki KUGIMOTO, Tokyo (JP); Yoichi HOSOKAWA, Tokyo (JP)

(73) Assignee: SUMITOMO OSAKA CEMENT CO., LTD., Tokyo (JP)

(21) Appl. No.: 17/042,816

(22) PCT Filed: Feb. 27, 2019
(86) PCT No.: PCT/JP2019/007610

§ 371 Date: Sep. 28, 2020

(30) Foreign Application Priority Data
Mar. 29, 2018 (JP) 2018-065363

(51) Int. Cl. G02F 1/035

(52) U.S. Cl. CPC G02F 1/0356; G02F 2202/28; G02F 2201/127

(57) ABSTRACT

Provided is an optical modulator that includes an adhesive layer whose thickness can be reduced and that ensures high reliability, while band-widening and low voltage drive are realized.

An optical modulator includes features as follows: a substrate (optical waveguide substrate) having an electro-optic effect; an optical waveguide formed on the substrate; and a traveling-wave electrode (signal electrode and ground electrode) formed on the substrate in order to modulate a light wave propagating through the optical waveguide, in which the substrate has a thickness of 30 μm or lower, a reinforcing substrate that holds the substrate through an adhesive layer interposed between the reinforcing substrate and the substrate is provided, and the adhesive layer includes an air gap section where no adhesive agent is present.

### TECHNICAL FIELD

The present invention relates to an optical modulator, and particularly, relates to an optical modulator in which a substrate having an electro-optic effect and a thickness of 30 μm or lower is used.

### BACKGROUND ART

In recent years, higher speed and capacity of an optical communication system have been progressing, and for example, an optical communication system having a communication speed of 100 GHz or higher per one wavelength has been considered practical. From now on, band-widening of the optical modulator, which is a basic component, will be much more demanded.

A traveling-wave optical modulator causes light waves propagating through an optical waveguide and microwaves propagating through an electrode (traveling-wave electrode) provided along the optical waveguide to interact with each other due to an electro-optic effect, thereby modulating the light wave. In particular, band-widening can be realized by achieving velocity matching of the light wave with the microwave.

As a method of realizing the velocity matching, a configuration in which an electrode is formed on a buffer layer that has a low dielectric constant and that is provided on an optical waveguide substrate has been used in the related art. However, in this configuration, since an electric field applied to the optical waveguide decreases due to the presence of the buffer layer, there is a problem that voltage reduction of a drive voltage may not be realized.

In order to solve this problem, there is suggested a traveling-wave optical modulator in which an optical waveguide substrate is made to be a thin plate as shown in FIG. 1 (for example, refer to Patent Literature No. 1). In FIG. 1, the optical waveguide substrate on which an optical waveguide is formed is fixed to a reinforcing substrate with an adhesive layer. As the optical waveguide substrate, a substrate formed of a material having an electro-optic effect, such as lithium niobate, is used. The reinforcing substrate is formed of a material having a linear expansion coefficient equal to or close to that of the optical waveguide substrate, such as lithium niobate or quartz glass. A thickness of the optical waveguide substrate is 30 μm or lower, and the thickness of the optical waveguide is far thinner than a thickness of a substrate used for a general optical modulator of about 500 μm.

Regarding the adhesive layer, it is necessary to use an adhesive agent having a dielectric constant lower than that of the optical waveguide substrate. In addition, a thickness of the adhesive layer is made sufficiently thick (for example, 50 μm to 200 μm) so that an electric field applied from electrodes (a signal electrode and a ground electrode) largely leaks to the adhesive layer. In this way, the electric field from the electrodes leaks into the low dielectric constant adhesive layer, so that an equivalent refractive index for the microwave (a value of the equivalent refractive index for the microwave is greater than an equivalent refractive index for the light wave) is smaller than that of the case in which the thickness of the optical waveguide substrate is thick.

In this way, since a difference between the equivalent refractive index of the light wave and the equivalent refractive index of the microwave is small, velocities of the light wave and the microwave are nearly in a matched state, and thus band-widening is realized. Furthermore, in this structure, since the velocity matching can be achieved without providing a buffer layer on the optical waveguide substrate, it is possible to suppress a decrease in the electric field strength applied to the optical waveguide. As a result, the velocity matching and the drive voltage reduction can be realized at the same time.

Here, regarding the adhesive layer in FIG. 1, the following problems have become apparent. In general, since a material used for the adhesive layer (for example, adhesive glass such as glass frit or a resin material such as acrylic or epoxy) has a dielectric constant of about 3 to 8, it is necessary to have a certain thickness of, for example, about 50 μm to 200 μm in order to sufficiently reduce a difference between the equivalent refractive indices.

In a case in which the thickness of the adhesive layer is increased as described above, firstly, there is a problem that the adhesive strength is decreased. Secondly, in a case in which the temperature of the adhesive agent increases due to ultraviolet irradiation or heating during curing, and the temperature decreases after the adhesive agent is cured, stress due to a difference in linear expansion coefficient between the adhesive agent (adhesive layer) and the optical waveguide substrate or reinforcing substrate is generated. Thus, as the adhesive layer is thick, the stress is also large. Thirdly, it is difficult to cut an adhesive layer formed thick into chips, so that a yield is decreased.

### CITATION LIST

### Patent Literature

[Patent Literature No. 1] Japanese Laid-open Patent Publication No. 2006-301612

### SUMMARY OF INVENTION

### Technical Problem

An object of the present invention to be achieved is to solve the above described problem and to provide an optical modulator that includes an adhesive layer whose thickness can be reduced and that ensures high reliability, while band-widening and low voltage drive are realized.

### Solution to Problem

In order to achieve the above object, the optical modulator of the present invention has the following technical features.

(1) An optical modulator includes: a substrate having an electro-optic effect; an optical waveguide formed on the substrate; and a traveling-wave electrode formed on the substrate in order to modulate a light wave propagating through the optical waveguide, in which the substrate has a thickness of 30 μm or lower, a reinforcing substrate that holds the substrate through an adhesive layer interposed between the reinforcing substrate and the substrate is provided, and the adhesive layer includes an air gap section where no adhesive agent is present.

(2) In the optical modulator according to (1), a proportion of the air gap section to an entirety of the adhesive layer is 25% by volume to 60% by volume.

(3) In the optical modulator according to (1) or (2), the adhesive layer includes an adhesive agent and a hollow fine particle.

(4) In the optical modulator according to (3), the hollow fine particle is anyone of hollow silica, mesoporous-based silica, hollow alumina, and a hollow resin bead, or a mixture of two or more of the above components.

(5) In the optical modulator according to (3) or (4), a surface of the hollow fine particle is surface-modified with a surface treatment agent.

### Advantageous Effects of Invention

In the present invention, the optical modulator includes a substrate having an electro-optic effect, an optical waveguide formed on the substrate, and a traveling-wave electrode formed on the substrate in order to modulate a light wave propagating through the optical waveguide, in which the substrate has a thickness of 30 μm or lower, a reinforcing substrate that holds the substrate through an adhesive layer interposed between the reinforcing substrate and the substrate is provided, and the adhesive layer includes an air gap section where no adhesive agent is present. Therefore, it is possible to decrease an average dielectric constant of an entirety of the adhesive layer, and as a result, possible to form the adhesive layer having the thinner thickness than that of the related art.

Thereby, it is possible to overcome disadvantages that the decrease in the adhesive strength, the increase in the stress due to the difference in the linear expansion coefficient, the decrease in the yield in a case of cutting into chips, and the like, which are occurred in a case in which the thickness of the adhesive layer is large.

### BRIEF DESCRIPTION OF DRAWINGS

FIG. 1 is a sectional view showing an outline of an optical modulator to which the present invention is applied.

### DESCRIPTION OF EMBODIMENTS

Hereinafter, the optical modulator of the present invention will be described in detail with reference to suitable examples.

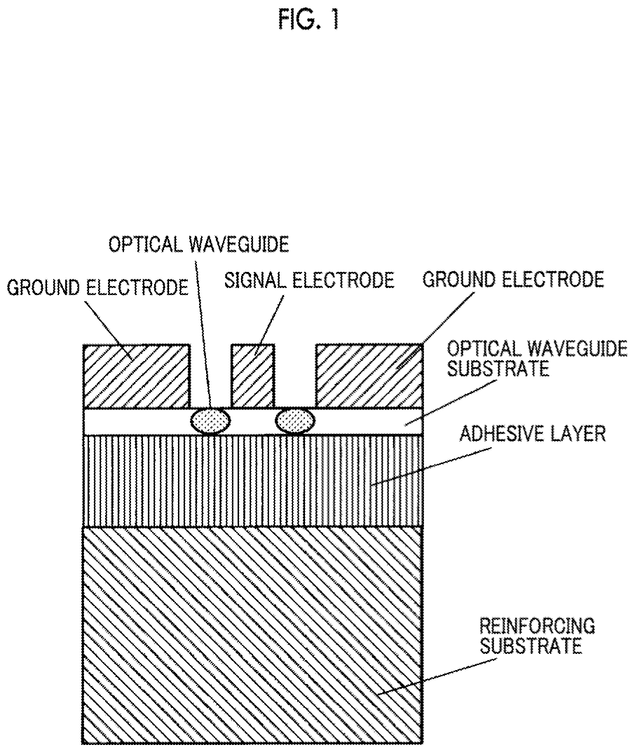

In the present invention, as shown in FIG. 1, the optical modulator includes features as follows: a substrate (optical waveguide substrate) having an electro-optic effect; an optical waveguide formed on the substrate; and a traveling-wave electrode (signal electrode and ground electrode) formed on the substrate in order to modulate a light wave propagating through the optical waveguide, in which the substrate has a thickness of 30 μm or lower, a reinforcing substrate that holds the substrate through an adhesive layer interposed between the reinforcing substrate and the substrate is provided, and the adhesive layer includes an air gap section where no adhesive agent is present. In addition, a proportion of the air gap section to an entirety of the adhesive layer is 25% by volume to 60% by volume.

As the optical waveguide substrate, a substrate formed of a material having an electro-optic effect, such as lithium niobate (LN), can be suitably used. The thickness of the substrate is also preferably 30 μm or lower, and more preferably 10 μm or lower.

As a method of providing the air gap section in the adhesive layer, it is considered to form a space (region) in the adhesive layer, on which no adhesive agent is provided; however, there is a difference in the stress applied to the optical waveguide substrate between a portion with the adhesive agent and a portion without the adhesive agent, so that internal distortion in the optical waveguide substrate occurs.

On the other hand, as a method of forming an air gap in the adhesive layer of the present invention, air gaps are formed by dispersing hollow fine particles in the adhesive agent. Thereby, since the air gaps are formed inside the hollow fine particles, a shape of the adhesive layer is stably maintained unless shapes of the hollow fine particles change or unless a large amount of air in the hollow fine particles gets into the adhesive agent.

As the hollow fine particles used in the present invention, it is possible to use any type of fine particles A configured to have shells surrounding inner cavities or fine particles B having a large number of internal cavities communicating with the outside such as porous fine particles. In the porous fine particles B, air in the cavities may expand or contract due to the temperature change, so that there is a possibility that the air gets into or out of the fine particle circumferentially (in the adhesive agent). Therefore, since a volume of the adhesive layer may be slightly changed according to the temperature change, it can be said that the fine particles A are more suitable for the present invention than the fine particles B.

In addition, as a material for forming the hollow fine particles, an inorganic material such as silica or alumina may be used, or a resin may be used. Regarding the resin in which cavities are included, since a volume of the fine particle changes in a case in which the air inside the cavity expands or contracts, so that the used material is preferably an inorganic material that is hardly affected by the temperature change.

As the hollow fine particles that can be more suitably used in the present invention, any one of hollow silica, mesoporous-based silica, hollow alumina, and a hollow resin bead, or a mixture of two or more of the above components is preferable.

It is preferable that a particle diameter of the hollow fine particle is 1 to 5 μm or lower, and more preferably 100 to 300 nm or lower, in a case of taking in consideration that the thickness of the adhesive layer is preferably set to 50 μm or lower. In the case of a shell in which a cavity is included, it is preferable that the thickness of the shell is ⅕ or lower of the particle diameter, and more preferably 1/10 or lower of the particle diameter from the viewpoint that the larger air gap can be formed.

As the adhesive agent used for the adhesive layer, a vehicle having a low dielectric constant (for example, a dielectric constant of 5 or lower) and capable of holding the hollow fine particles in a dispersed state is preferable. Specifically, resin material-based adhesive agents such as acrylic, epoxy, and silicon can be suitably used.

In addition, the larger the volume of the hollow fine particles to be dispersed in the adhesive agent, the better. On the contrary, there is concern that in a case of increasing the volume of the hollow fine particles, the volume of the adhesive agent may be reduced and the adhesive strength may be decreased. Therefore, in order to increase the adhesive strength between the hollow fine particles and the adhesive agent, it is more preferable to modify surfaces of the hollow fine particles with a surface treatment agent containing a functional group having good reactivity or affinity with a resin used for the vehicle.

In a case in which the configuration of the present invention has been used, how the characteristics of the adhesive layer change will be described below.

For example, LN is used as the optical waveguide substrate, and a thickness of the substrate is set to 10 μm. In a case in which the adhesive layer is an acrylic-based adhesive agent (dielectric constant of 3.5), conditions for the thickness of the adhesive layer necessary to make equivalent refractive indices of the light wave and the microwave almost equal (Δ≤0.03) are as shown in the following Table 1. Porosity in the adhesive layer is increased, so that the dielectric constant of the adhesive layer is decreased, and the equivalent refractive indices of the light wave and the microwave can be matched even though the thickness of the adhesive layer is reduced.

TABLE 1

| Porosity in | | Thickness of |
|---|---|---|
| adhesive layer | Dielectric | adhesive layer |
| % by volume | constant | μm |
| 0 | 3.5 | 70 |
| 32.5 | 2.7 | 50 |
| 45.8 | 2.3 | 35 |
| 58.5 | 1.9 | 20 |

An example of mixing hollow silica in an adhesive agent vehicle (binder) includes a method of forming air gaps in the adhesive layer. The porosity and the dielectric constant in the adhesive layer in a case in which an acrylic-based adhesive agent (dielectric constant of 3.5) is used as a vehicle, and hollow silica (particle diameter of 100 nm, outer shell thickness of 10 nm) is mixed in the vehicle are shown in FIG. 2.

TABLE 2

| Blending ratio of | | Porosity in | |
|---|---|---|---|
| hollow silica | Vehicle ratio | adhesive layer | Dielectric |
| % by volume | % by volume | % by volume | constant |
| 0 | 100 | 0 | 3.5 |
| 50 | 50 | 33 | 2.7 |
| 70 | 30 | 46 | 2.3 |
| 90 | 10 | 59 | 1.9 |

The porosity of the adhesive layer can be sufficiently increased by blending 50% to 90% by volume of hollow silica in the vehicle.

However, in a case in which the hollow silica is simply mixed with the adhesive agent (vehicle), there is a problem that sufficient adhesive strength cannot be obtained as a blending proportion of the hollow silica increases. In order to overcome this problem, it is preferable to modify a surface of the hollow silica with a surface treatment agent containing a functional group having good reactivity or affinity with a resin used for the vehicle. The surface treatment agent is not particularly limited as long as the surface treatment agent contains a functional group having good reactivity or affinity with a resin used for the vehicle, but a silane coupling agent, a titanate coupling agent, an isocyanate-based treatment agent, or the like is suitably used. In particular, the surface can be easily modified by using a silicon alkoxide-based modifier such as a silane coupling agent.

As described above, by including the air gaps in the adhesive layer, it is possible to provide the adhesive layer having a low dielectric constant and a dielectric constant of <3.0. Furthermore, even though the number of the air gaps is increased in the adhesive layer having a low dielectric constant, sufficient adhesive strength in the adhesive layer can be maintained by increasing the adhesive strength between the hollow fine particles and the adhesive agent.

As described above, the dielectric constant of the adhesive layer can be suppressed to a low level, so that it is possible to realize the band-widening and the drive voltage reduction, and to reduce the thickness of the adhesive layer by decreasing the dielectric constant compared with that of the conventional resin-based adhesive agent. Therefore, stress generated during curing is reduced and reliability in an optical waveguide device (optical modulator) can be improved. In addition, in a case of forming the thin adhesive agent layer, chip cutting or the like is easily carried out. Therefore, the yield is improved, and the manufacturing cost can be suppressed.

In the description below, a method of manufacturing an adhesive layer that can be used for the optical modulator of the present invention is specifically exemplified.

In the description below, since an acrylic-based adhesive agent is used as the vehicle resin, the surface modification of the hollow silica was performed with a silane coupling agent containing an acryloyl group.

(Production of Hollow Silica Surface Modification No. 1)

40 parts by mass of hollow silica, 10 parts by mass of 3-acryloxypropyltrimethoxysilane, 1.5 parts by mass of nitric acid, 1.5 parts by mass of water, and 47 parts by mass of isopropyl alcohol were mixed, and the mixture was stirred for 6 hours at room temperature to obtain a surface-modified hollow silica dispersion.

(Production of Hollow Silica Surface Modification No. 2)

Hollow silica surface modification No. 2 was obtained in the same manner as in hollow silica surface modification No. 1, except that the surface modifier was changed to 3-methacryloxypropyltrimethoxysilane.

In a case in which a state of the modified hollow silica was measured with the 29SiNMR method, it was confirmed that the silane coupling agent reacted with the hollow silica. Since similar results were obtained with any of the surface modifiers, the dispersion of No. 1, which had higher reactivity with acrylic and which was obtained using 3-acryloxypropyltrimethoxysilane, was used in subsequent experiments.

### (Example 1) Production of Adhesive Agent Containing 50% by Volume of Surface-Modified Hollow Silica

100 parts by mass of the obtained surface-modified hollow silica dispersion No. 1, 35 parts by mass of 2-ethylhexyl acrylate, 15 parts by mass of N-vinylpyrrolidone, and 1-hydroxy-cyclohexyl were mixed, an isopropyl alcohol contained in the hollow silica dispersion No. 1 was removed by an evaporator, and thereafter, 1.0 part by mass of 1-hydroxy-cyclohexyl-phenyl-ketone was added to obtain an adhesive agent containing hollow silica. The porosity of the adhesive layer when this adhesive agent was applied was 28%.

### (Example 2) Production of Adhesive Agent Containing 70% by Volume of Surface-Modified Hollow Silica

140 parts by mass of the obtained surface-modified hollow silica dispersion No. 1, 21 parts by mass of 2-ethylhexyl acrylate, 9 parts by mass of N-vinylpyrrolidone, and 1-hydroxy-cyclohexyl were mixed, an isopropyl alcohol contained in the hollow silica dispersion No. 1 was removed by an evaporator, and thereafter, 1.0 part by mass of 1-hydroxy-cyclohexyl-phenyl-ketone was added to obtain an adhesive agent containing hollow silica. The porosity of the adhesive layer when this adhesive agent was applied was 40%.

### (Example 3) Production of Adhesive Agent Containing 90% by Volume of Surface-Modified Hollow Silica

180 parts by mass of the obtained surface-modified hollow silica dispersion No. 1, 7 parts by mass of 2-ethylhexyl acrylate, 3 parts by mass of N-vinylpyrrolidone, and 1-hydroxy-cyclohexyl were mixed, an isopropyl alcohol contained in the hollow silica dispersion No. 1 was removed by an evaporator, and thereafter, 1.0 part by mass of 1-hydroxy-cyclohexyl-phenyl-ketone was added to obtain an adhesive agent containing hollow silica. The porosity of the adhesive layer when this adhesive agent was applied was 53%.

### (Comparative Example 1) Production of Adhesive Agent Containing No Hollow Silica

70 parts by mass of 2-ethylhexyl acrylate, 30 parts by mass of N-vinylpyrrolidone, and 1-hydroxy-cyclohexyl were mixed, and 1.0 part by mass of 1-hydroxy-cyclohexyl-phenyl-ketone was added to obtain an adhesive agent. The porosity of the adhesive layer when this adhesive agent was applied was 0%.

### (Comparative Example 2) Production of Adhesive Agent Containing 50% by Volume of Surface-Unmodified Hollow Silica

50 parts by mass of the obtained hollow silica, 35 parts by mass of 2-ethylhexyl acrylate, 15 parts by mass of N-vinylpyrrolidone, and 1-hydroxy-cyclohexyl were mixed, dispersion processing was performed by a ball mill for 6 hours, and thereafter, 1.0 part by mass of 1-hydroxy-cyclohexyl-phenyl-ketone was added to obtain an adhesive agent containing hollow silica. The porosity of the adhesive layer when this adhesive agent was applied was 33%.

### (Comparative Example 3) Production of Adhesive Agent Containing 70% by Volume of Surface-Unmodified Hollow Silica

70 parts by mass of the obtained hollow silica, 21 parts by mass of 2-ethylhexyl acrylate, 9 parts by mass of N-vinylpyrrolidone, and 1-hydroxy-cyclohexyl were mixed, dispersion processing was performed by a ball mill for 6 hours, and thereafter, 1.0 part by mass of 1-hydroxy-cyclohexyl-phenyl-ketone was added to obtain an adhesive agent containing hollow silica. The porosity of the adhesive layer when this adhesive agent was applied was 46%.

### (Comparative Example 4) Production of Adhesive Agent Containing 90% by Volume of Surface-Unmodified Hollow Silica

90 parts by mass of the obtained hollow silica, 7 parts by mass of 2-ethylhexyl acrylate, 3 parts by mass of N-vinylpyrrolidone, and 1-hydroxy-cyclohexyl were mixed, dispersion processing was performed by a ball mill for 6 hours, and thereafter, 1.0 part by mass of 1-hydroxy-cyclohexyl-phenyl-ketone was added to obtain an adhesive agent containing hollow silica. The porosity of the adhesive layer when this adhesive agent was applied was 59%.

In a case in which an optical waveguide device having the configuration of FIG. 1 (the optical waveguide substrate is formed of LN and the thickness is 10 μm) was produced using the obtained adhesive agent, the dielectric constant and the difference between an equivalent refractive index of the light wave and an equivalent refractive index of the microwave were measured as an matching degree (ΔNm). In addition, regarding the adhesive strength, the obtained adhesive layers were formed to have thicknesses of 70 μm and 35 μm, respectively, between two blue glass sheets, each of which has a thickness of 1 mm, the resultant structure was irradiated with 10 mJ/cm² of UV light from a high-pressure mercury lamp to be cured, and the cured structure was subjected to shear adhesive strength measurement. The results are shown in Table 3.

TABLE 3

| | | | Thickness of | | Thickness of | |
|---|---|---|---|---|---|---|
| | | | adhesive layer | | adhesive layer | |
| | Porosity | | 70 μm | | 35 μm | |
| | % by | Dielectric | | Adhesive | | Adhesive |
| | volume | constant | ΔNm | strength | ΔNm | strength |
| Example 1 | 28 | 3.0 | B | B | C | A |
| Example 2 | 40 | 2.5 | B | B | B | A |
| Example 3 | 53 | 2.2 | B | B | B | B |
| Comparative | 0 | 3.5 | B | B | D | A |
| Example 1 | | | | | | |
| Comparative | 33 | 2.7 | B | D | C | C |
| Example 2 | | | | | | |
| Comparative | 46 | 2.3 | B | D | B | D |
| Example 3 | | | | | | |
| Comparative | 59 | 1.9 | B | D | B | D |
| Example 4 | | | | | | |

(Explanation of Each Symbol in Table 3)

Regarding ΔNm, “B” denotes 0.05 or lower, “C” denotes 0.05 to 0.10, and “D” denotes 0.10 or higher.

Regarding the adhesive strength, “A” denotes 7 MPa or higher, “B” denotes 7 to 5 MPa, “C” denotes 5 MPa or lower and 3 MPa, and “D” denotes 3 MPa or lower.

It can be seen that in Examples 1 to 3, the adhesive strength can be maintained even though the porosity is increased, whereas in Comparative Examples 2 and 3, the adhesive strength extremely decreases in a case in which the porosity is increased.

Since surfaces of particles in the hollow silica dispersions used in Examples 1 to 3 were modified with acryloyl groups, the particles were cross-linked with the resin used in the vehicle during curing, and thus, the coupling degree of resin-particle was increased. Therefore, it is considered that sufficient adhesive strength could be obtained.

According to this manner, the porosity in the adhesive layer can be increased, and the equivalent refractive indices of the light wave and the microwave can be matched even though the thickness of the adhesive layer is reduced. In addition, it is possible to prevent a decrease in the adhesive strength that occurs in a case in which the porosity is increased.

### INDUSTRIAL APPLICABILITY

As described above, according to the present invention, it is possible to provide the optical modulator that includes the adhesive layer whose thickness can be reduced and that ensures high reliability, while band-widening and low voltage drive are realized.

We claim:

1. An optical modulator comprising:
a substrate having an electro-optic effect;
an optical waveguide formed on the substrate; and
a traveling-wave electrode formed on the substrate in order to modulate a light wave propagating through the optical waveguide,
wherein the substrate has a thickness of 30 μm or lower,
a reinforcing substrate that holds the substrate through an adhesive layer interposed between the reinforcing substrate and the substrate is provided, and
the adhesive layer includes an air gap section where no adhesive agent is present.

2. The optical modulator according to claim 1, wherein a proportion of the air gap section to an entirety of the adhesive layer is 25% by volume to 60% by volume.

3. The optical modulator according to claim 1, wherein the adhesive layer comprises an adhesive agent and a hollow fine particle.

4. The optical modulator according to claim 3, wherein the hollow fine particle is any one of hollow silica, mesoporous-based silica, hollow alumina, and a hollow resin bead, or a mixture of two or more of the above components.

5. The optical modulator according to claim 3, wherein a surface of the hollow fine particle is surface-modified with a surface treatment agent.

6. The optical modulator according to claim 2, wherein the adhesive layer comprises an adhesive agent and a hollow fine particle.

7. The optical modulator according to claim 6, wherein the hollow fine particle is any one of hollow silica, mesoporous-based silica, hollow alumina, and a hollow resin bead, or a mixture of two or more of the above components.

8. The optical modulator according to claim 6, wherein a surface of the hollow fine particle is surface-modified with a surface treatment agent.

9. The optical modulator according to claim 4, wherein a surface of the hollow fine particle is surface-modified with a surface treatment agent.

10. The optical modulator according to claim 7, wherein a surface of the hollow fine particle is surface-modified with a surface treatment agent.
